(19) United States
(12) Patent Application Publication
(10) Pub. No.: US 2022/0391196 A1
(43) Pub. Date: Dec. 8, 2022

(54) LIGHT ASSEMBLY SYSTEM INCLUDING A LIGHT ASSEMBLY AND A SOFTWARE REFLASH KIT AND A METHOD OF OPERATION

(71) Applicant: VARROC LIGHTING SYSTEMS, s.r.o., Senov u Nového Jicína (CZ)

(72) Inventors: David Grasso, Trenton, MI (US); Manuel Pena, Northville, MI (US); Steven Susanka, Garden City, MI (US); Jose Cutberto Medina Padilla, Novi, MI (US)

(21) Appl. No.: 17/341,236

(22) Filed: Jun. 7, 2021

(51) Int. Cl. G06F 8/656; H05B 45/30; H01R 12/71; H01R 13/15

(52) U.S. Cl. CPC G06F 8/656; H05B 45/30; H01R 12/714; H01R 13/15

(57) ABSTRACT

A light assembly system includes a light assembly and a software reflash kit for updating software of an internal control unit of the light assembly. The light assembly is constructed for releasable receipt of an electrical communication device of the software reflash kit. The light assembly includes a housing, the control unit, and an access port. The housing defines an enclosed, sealable, chamber. The control unit is located in the chamber. The access port is defined by and communicates through, the housing, and is adapted to receive the electrical communication device for detachable electrical engagement to the control unit.

### INTRODUCTION

The subject disclosure relates to a light assembly, and more particularly to a light assembly adapted for use with a software reflash kit.

Light assemblies, such as those used in vehicles, are known to include housings that define a chamber. Various light sources and light propagation structures may be located in the chamber along with a control unit (i.e., microprocessor) that executes software to control lighting attributes. In such lighting assemblies, the chamber is sealed to protect the internal components and prevent ingress of moisture and dirt into the chamber. Unfortunately, once the chamber is sealed, changes, updates, and/or software reflashes of the control unit is difficult to accomplish and expensive.

Accordingly, it is desirable to provide an inexpensive, simple, and robust way to update or change the software of the control unit with the ability to re-seal the chamber.

### SUMMARY

A light assembly constructed for releasable receipt of an electrical communication device, the light assembly according to one, non-limiting, embodiment of the present disclosure includes a housing, a control unit, and an access port. The housing defines an enclosed, sealable, chamber. The control unit is located in the chamber. The access port is defined by and communicates through the housing, and is adapted to receive the electrical communication device for detachable electrical engagement to the control unit.

Additionally to the foregoing embodiment, the light assembly includes a plug adapted to seal the access port when the electrical communication device is not in use.

In the alternative, or additionally thereto, in the foregoing embodiment, the plug is an adhesive patch.

In the alternative, or additionally thereto, in the foregoing embodiment, the control unit is a printed circuit board.

In the alternative, or additionally thereto, in the foregoing embodiment, the printed circuit board includes a LED driver module.

In the alternative, or additionally thereto, in the foregoing embodiment, the printed circuit board includes a pin receptacle adapted to electrically receive a pin of the electrical communication device extending through the access port when connected.

In the alternative, or additionally thereto, in the foregoing embodiment, the pin receptacle is aligned to the access port for releasable receipt of the pin.

In the alternative, or additionally thereto, in the foregoing embodiment, the pin is a POGO pin.

In the alternative, or additionally thereto, in the foregoing embodiment, the control unit includes a pin receptacle adapted to electrically receive a pin of the electrical communication device, and wherein the pin extends through the access port when connected.

In the alternative, or additionally thereto, in the foregoing embodiment, the pin receptacle is aligned to the access port for releasable receipt of the pin.

In the alternative, or additionally thereto, in the foregoing embodiment, the control unit includes a processor, an electronic storage medium, and software stored in the storage medium and executed by the processor, and wherein the electrical communication device is configured to change the software.

An electrical communication device kit adapted to releasable attach to an internal control unit of a light assembly through a sealable access port in a housing of the light assembly, the electrical communication device kit according to another, non-limiting, embodiment includes an electric communication device and a plug. The electrical communication device includes a base and a plurality of pins adapted to extend through the access port and releasably, electrically, engage the internal control unit. The plug is adapted to attach to the housing and seal the access port when the plurality of pins are not extending through the access port.

Additionally to the foregoing embodiment, the plurality of pins are POGO pins.

In the alternative, or additionally thereto, in the foregoing embodiment, the electrical communication device is a dongle.

In the alternative, or additionally thereto, in the foregoing embodiment, the plug is an adhesive patch.

In the alternative, or additionally thereto, in the foregoing embodiment, the electrical communication device is configured to transmit software to the internal control unit.

A method of reflashing software in an electronic storage medium of a control unit located in a sealable chamber of a light assembly is defined by a housing. The method according to another, non-limiting, embodiment, includes a step of inserting a detachable electrical communication device through an access port in a housing of the light assembly. The electrical communication device is then electrically connected to the control unit. The software in the electronic storage medium is then changed via the electrical communication device. The electrical communication device is then detached from the control unit. The electrical communication device is then withdrawn from the access port. The access port is then plugged with a plug.

Additionally to the foregoing embodiment, the plug is an adhesive patch.

In the alternative, or additionally thereto, in the foregoing embodiment, the detachable electrical communication device includes a base and a pin, and the base is located externally to the light assembly when the pin is extended through the access hole and is electrically engaged to the control unit.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a partial cross section of a light assembly system including a light assembly and a software reflash kit adapted to support the light assembly;

FIG. 2 is a partial, disassembled, perspective view of the light assembly;

FIG. 3 is a plan view of a control unit of the light assembly;

FIG. 4 is a partial perspective view illustrating a base of an electrical communication device of the software reflash kit inserted partially through an access port in a housing;

FIG. 5 is a partial perspective view (generally opposite to that of FIG. 4) illustrating pins of the electrical communication device detachably inserted into the control unit; and

FIG. 6 is a flow chart illustrating a method of reflashing software stored in the electronic storage medium of the control unit.

### DETAILED DESCRIPTION

The following description is merely exemplary in nature and is not intended to limit the present disclosure, its application or uses. It should be understood that throughout the drawings, corresponding reference numerals indicate like or corresponding parts and features.

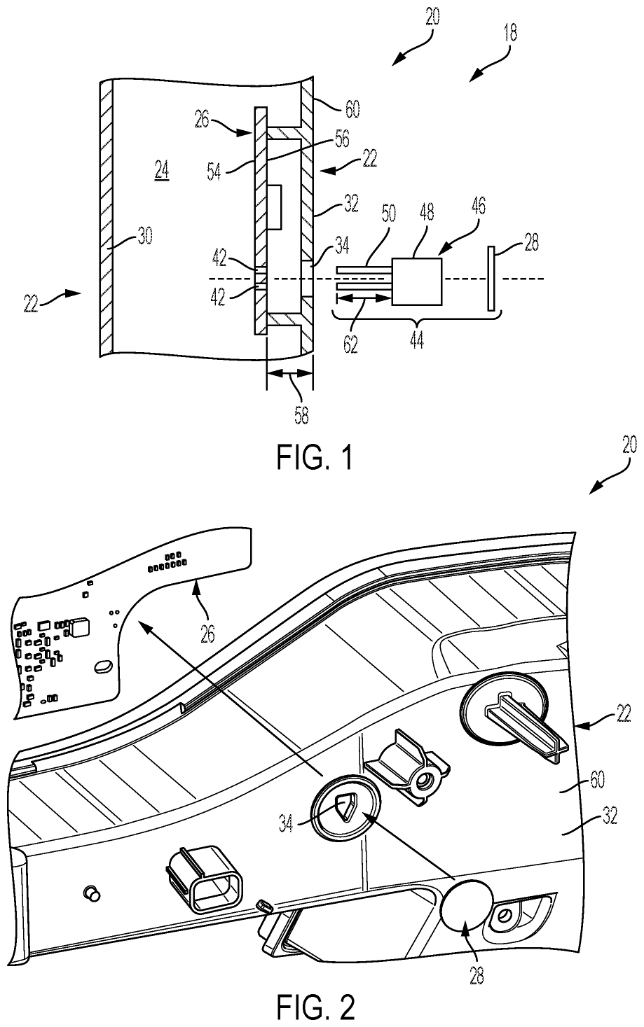

In accordance with an exemplary embodiment, a light assembly system 18 is illustrated in FIG. 1. In one embodiment, the light assembly system 18 is adapted for use in a vehicle (not shown). Non-limiting examples of the vehicle light assembly system 18 include a rear tail assembly, a rear stop assembly, a rear turn assembly, a front turn assembly, a rear fog assembly, a low beam assembly, a high beam assembly, headlight assembly, a taillight assembly, and other applications that may use light emitting diodes (LEDs).

Referring to FIGS. 1 and 2, the light assembly system 18 includes a light assembly 20 and a software reflash kit 44. The light assembly 20 includes a housing 22, a sealable chamber 24 defined by the housing 22, a control unit 26 located in the chamber 24, and a plug 28. The housing 22 includes a lens, or lens portion 30 through which light is transmitted, and a back portion 32 that may be opaque. An access port 34 is defined by, and communicates through, the housing 22. In one example, the access port 34 is defined by the back portion 32 of the housing 22.

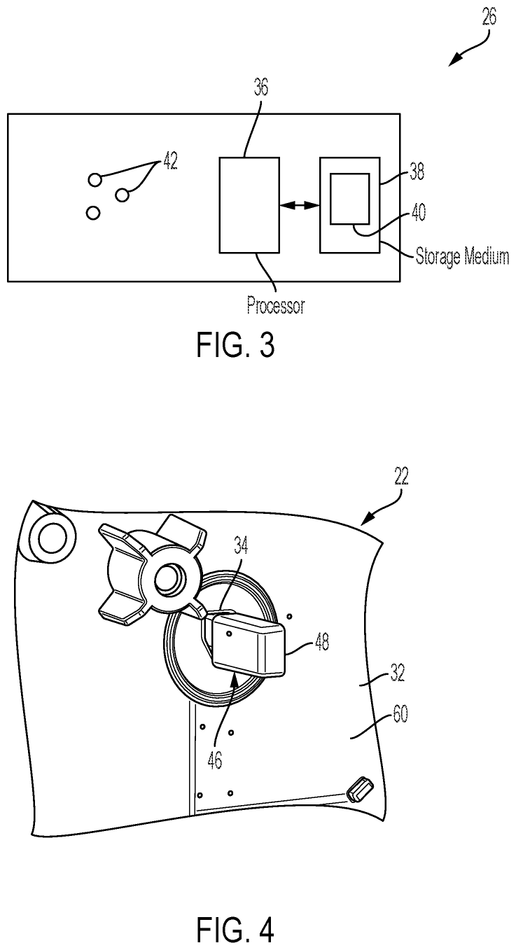

In one example, the control unit 26 may be a printed circuit board, PCB, fixed and attached to the back portion 32 of the housing 22. Referring to FIG. 3, the control unit 26 includes a processor 36 (e.g., microprocessor), an electronic storage medium 38, software 40, and a plurality of pin receptacles 42. The software 40 is stored in the electronic storage medium 28 and is executed by the processor 36. The electronic storage medium 28 may be computer readable and writeable, and non-transitory. In one embodiment, the control unit 26 is, or may include, a light emitting diode (LED) driver module. It is understood that the term “module” may mean, or may include, a microprocessor and an electronic storage medium for storing executable instructions or software. The electronic storage medium may be non-transitory.

With continued reference to FIG. 1, the software reflash kit 44 of the light assembly system 18 includes an electrical communication device 46 and may further include the plug 28 (i.e., replacement plug). The electrical communication device 46 includes a base 48 and a plurality of pins 50 (i.e., two illustrated in FIG. 1) that project outward from the base 48 and in a common direction. The base 48 may include a transceiver (not shown) for wireless communication between the device 46 and an external source. In another example, the base 48 may facilitate a hard wire electrical connection to the pins 50. In one example, the pins 50 are POGO pins (i.e., spring loaded pins).

The plurality of receptacles 42 of the control unit 26 are aligned to the access port 34 in the housing 22. That is, the receptacles 42 are directly in front of the access port 34. The control unit 26 (e.g., PCB) includes a forward face 54 and an opposite rearward face 56. In one example, the rearward face 56 is located at a distance (see arrow 58) from an exterior surface 60 the housing 22. In comparison, the pins 50 each have a length (i.e., see arrow 62) that is longer than the distance 58 to assure electrical connection of the pins 50 with the respective receptacle 42, while the base 48 remains outside of the housing 22. In this example, the size of the access port 34 is minimized to optimize resealing.

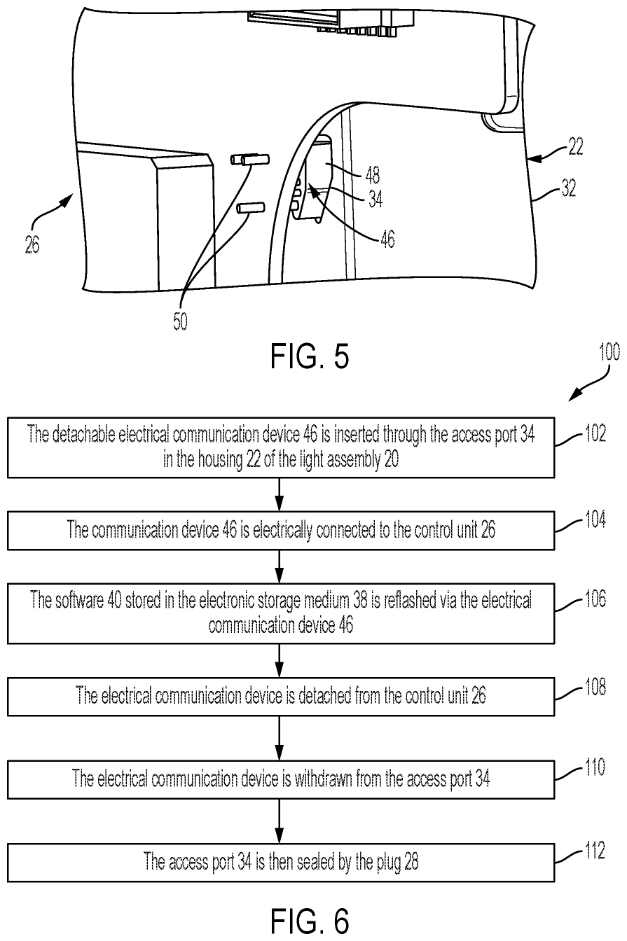

Referring to FIGS. 4 and 5, and in another example, the base 48 of the electrical communication device 46 may project partially through the back portion 32 of the housing 22. In yet another example, the electrical communication device 46 may be a dongle that may include a transceiver.

The plug 28 is constructed to seal the access port 34. In one example the plug 28 is removable, and may include threads (not shown) for threaded engagement with the back portion 32 of the housing 22. In another example, the plug 28 is an adhesive patch adapted to adhere to the exterior surface 60 of the back portion 32. In one example, the adhesive of the patch 28 may facilitate removal or ‘peeling-off’ of the patch from the housing 22.

Referring to FIG. 6, a method 100 of reflashing software 40, stored in the electronic storage medium 38, is illustrated. At block 102, the detachable electrical communication device 46 is inserted through the access port 34 in the housing 22 of the light assembly 20. At block 104, the communication device 46 is electrically connected to the control unit 26. At block 106, the software 40 stored in the electronic storage medium 38 is reflashed, changed, and/or updated via the electrical communication device 46. At block 108, the electrical communication device is detached from the control unit 26. At block 110, the electrical communication device is withdrawn from the access port 34. At block 112, the access port 34 is then sealed by the plug 28.

Advantages and benefits of the present disclosure includes the ability to repeatably and inexpensively reflash software typically sealed within a chamber of a light assembly during normal operation. Other advantages include a robust design that minimizes any risk of leakage into the sealed chamber. Yet another advantage is the elimination of any costly auxiliary programming port mounted to the housing of the light assembly.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof

What is claimed is:

1. A light assembly constructed for releasable receipt of an electrical communication device, the light assembly comprising:
a housing defining an enclosed, sealable, chamber;
a control unit located in the chamber; and
an access port defined by and communicating through the housing, and adapted to receive the electrical communication device for detachable electrical engagement to the control unit.

2. The light assembly set forth in claim 1, further comprising:
a plug adapted to seal the access port when the electrical communication device is not in use.

3. The light assembly set forth in claim 2, wherein the plug is an adhesive patch.

4. The light assembly set forth in claim 1, wherein the control unit is a printed circuit board.

5. The light assembly set forth in claim 4, wherein the printed circuit board includes a LED driver module.

6. The light assembly set forth in claim 4, wherein the printed circuit board includes a pin receptacle adapted to electrically receive a pin of the electrical communication device extending through the access port when connected.

7. The light assembly set forth in claim 6, wherein the pin receptacle is aligned to the access port for releasable receipt of the pin.

8. The light assembly set forth in claim 6, wherein the pin is a POGO pin.

9. The light assembly set forth in claim 1, wherein the control unit includes a pin receptacle adapted to electrically receive a pin of the electrical communication device, and wherein the pin extends through the access port when connected.

10. The light assembly set forth in claim 9, wherein the pin receptacle is aligned to the access port for releasable receipt of the pin.

11. The light assembly set forth in claim 1, wherein the control unit includes a processor, an electronic storage medium, and software stored in the storage medium and executed by the processor, and wherein the electrical communication device is configured to change the software.

12. An electrical communication device kit adapted to releasable attach to an internal control unit of a light assembly through a sealable access port in a housing of the light assembly, the electrical communication device kit comprising:
an electrical communication device including a base and a plurality of pins adapted to extend through the access port and releasably, electrically, engage the internal control unit; and
a plug adapted to attach to the housing and seal the access port when the plurality of pins are not extending through the access port.

13. The electrical communication device kit set forth in claim 12, wherein the plurality of pins are POGO pins.

14. The electrical communication device kit set forth in claim 12, wherein the electrical communication device is a dongle.

15. The electrical communication device kit set forth in claim 12, wherein the plug is an adhesive patch.

16. The electrical communication device kit set forth in claim 12, wherein the electrical communication device is configured to transmit software to the internal control unit.

17. A method of reflashing software in an electronic storage medium of a control unit located in a sealable chamber of a light assembly defined by a housing, the method comprising:
inserting a detachable electrical communication device through an access port in a housing of the light assembly;
electrically connecting the electrical communication device to the control unit;
changing the software in the electronic storage medium via the electrical communication device;
detaching the electrical communication device from the control unit;
withdrawing the electrical communication device from the access port; and
plugging the access port with a plug.

18. The method set forth in claim 17, wherein the plug is an adhesive patch.

19. The method set forth in claim 17, wherein the detachable electrical communication device includes a base and a pin, and the base is located externally to the light assembly when the pin is extended through the access hole and is electrically engaged to the control unit.
